(19) United States
(12) Patent Application Publication
(10) Pub. No.: US 2025/0334988 A1
(43) Pub. Date: Oct. 30, 2025

(54) SEMICONDUCTOR DEVICE

(71) Applicant: ROHM Co., Ltd., Kyoto (JP)

(72) Inventors: Daisuke Uchimoto, Kyoto (JP); Daisaku Shugo, Kyoto (JP)

(73) Assignee: ROHM Co., Ltd., Kyoto (JP)

(21) Appl. No.: 19/173,755

(22) Filed: Apr. 8, 2025

(30) Foreign Application Priority Data
Apr. 26, 2024 (JP) 2024-073090

(51) Int. Cl. G05F 1/59

(52) U.S. Cl. CPC G05F 1/59

(57) ABSTRACT

A semiconductor device includes a switch circuit and a leakage cancellation circuit. The switch circuit has at least one switch configured as a MOSFET connected between two terminals of a specific element. The leakage cancellation circuit has at least one MOS transistor configured as a MOSFET, is connected to the switch circuit at a specific node, and is configured to inject or extract a leakage current with respect to the specific node.

### CROSS-REFERENCE TO RELATED APPLICATION

This application claims the priority benefit of Japan application serial no. 2024-073090, filed on Apr. 26, 2024. The entirety of the above-mentioned patent application is hereby incorporated by reference herein and made a part of this specification.

### BACKGROUND

### Technical Field

The disclosure relates to a semiconductor device.

### Related Art

Conventionally, as a type of constant voltage generation circuit, an ED-type constant voltage source combining a depletion-type N-channel MOSFET (metal oxide semiconductor field effect transistor) and an enhancement-type N-channel MOSFET is widely and generally known.

### RELATED ART DOCUMENTS

### Patent Documents

[Patent Document 1] International Patent Publication No. 2021/172001

In a constant voltage generation circuit, there is room for improvement in the temperature characteristics of an output voltage. In addition, in attempting to make improvements, it is necessary to consider the influence due to a leakage current at high temperature.

### SUMMARY

A semiconductor device according to an aspect of the disclosure includes a switch circuit and a leakage cancellation circuit. The switch circuit has at least one switch configured as a MOSFET connected between two terminals of a specific element. The leakage cancellation circuit has at least one MOS transistor configured as a MOSFET, is connected to the switch circuit at a specific node, and is configured to inject or extract a leakage current with respect to the specific node.

### BRIEF DESCRIPTION OF THE DRAWINGS

FIG. 1 is a diagram showing a configuration of a constant voltage generation circuit according to a comparative example.

FIG. 2 is a diagram showing a configuration of a constant voltage generation circuit according to an exemplary embodiment of the disclosure.

FIG. 3 is a diagram showing a specific first configuration example of the constant voltage generation circuit.

FIG. 4 is a diagram showing an example of a table map.

FIG. 5 is a diagram schematically showing temperature characteristics.

FIG. 6 is a diagram showing an example of temperature characteristics of an output voltage.

FIG. 7 is a diagram showing a specific second configuration example of the constant voltage generation circuit.

FIG. 8 is a diagram showing another example of a table map.

FIG. 9 is a diagram showing a configuration of a first embodiment in which a leakage current countermeasure is implemented.

FIG. 10 is a diagram showing an example of a vertical structure of an NMOS transistor.

FIG. 11 is a diagram showing a configuration of a second embodiment in which a leakage current countermeasure is implemented.

FIG. 12 is a diagram showing a configuration of a third embodiment in which a leakage current countermeasure is implemented.

FIG. 13 is a diagram showing a configuration of a fourth embodiment in which a leakage current countermeasure is implemented.

FIG. 14 is an external perspective view showing an example of a semiconductor device.

### DETAILED DESCRIPTION

Embodiments of the disclosure provide a semiconductor device capable of suppressing the influence due to a leakage current at high temperature.

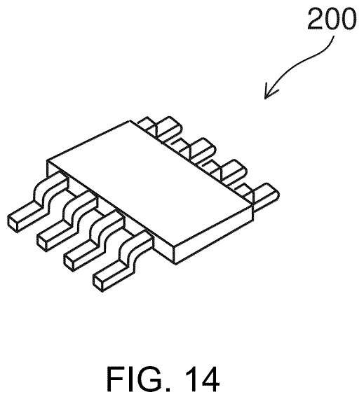

Hereinafter, exemplary embodiments of the disclosure will be described with reference to the drawings. A constant voltage generation circuit according to the present embodiment is provided in a semiconductor device. FIG. 14 is an external perspective view showing an example of a semiconductor device. A semiconductor device 200 shown in FIG. 14 is an electronic component that includes a semiconductor chip having a semiconductor integrated circuit formed on a semiconductor substrate, a housing (package) accommodating the semiconductor chip, and multiple external terminals exposed from the housing to outside the semiconductor device 200. The semiconductor device 200 is formed by encapsulating the semiconductor chip in the housing (package) composed of resin. The number of external terminals of the semiconductor device 200 and the type of the housing of the semiconductor device 200 shown in FIG. 14 are merely exemplary, and may be designed in any manner. The constant voltage generation circuit according to the present embodiment is included in the semiconductor integrated circuit.

### Comparative Example

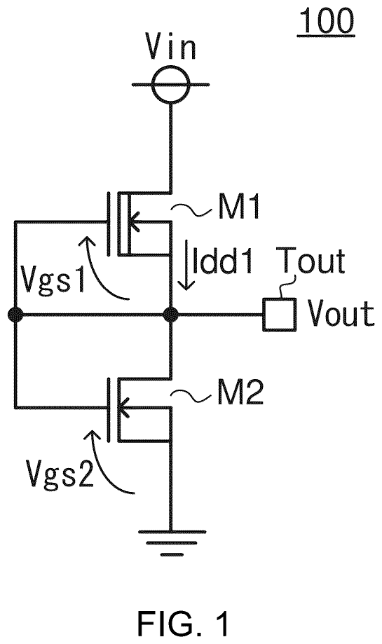

FIG. 1 is a diagram showing a comparative example (a basic configuration to be compared with the embodiment to be described later) of a constant voltage generation circuit. The constant voltage generation circuit 1 of the present comparative example is a so-called ED-type reference voltage source. According to this figure, the constant voltage generation circuit 1 includes a transistor M1 and a transistor M2. The transistor M1 is composed of a depletion-type N-channel MOSFET. The transistor M2 is composed of an enhancement-type N-channel MOSFET.

The depletion type refers to a type in which a drain current flows even when the gate-source voltage is 0 V. In contrast, the enhancement type refers to a type in which a drain current does not flow when the gate-source voltage is 0 V.

The drain of the transistor M1 is connected to an application terminal of an input voltage Vin. The source and the back gate of the transistor M2 are connected to a ground terminal (application terminal of a ground potential). The gate, the source, and the back gate of the transistor M1, and the gate and the drain of the transistor M2, are all connected to an output terminal Tout, which is an application terminal of an output voltage Vout.

In the constant voltage generation circuit 1 of the present comparative example, the gate and the source of the transistor M1 are short-circuited. Thus, a gate-source voltage Vgs1 of the transistor M1 is 0 V. Accordingly, the transistor M1 functions as a constant current source that generates a constant drain current Idd1. That is, a constant bias current (=drain current Idd1) flows to the transistor M2. As a result, a constant output voltage Vout equivalent to a gate-source voltage Vgs2 of the transistor M2 is generated.

Herein, when the currents respectively flowing to the transistors M1 and M2 operating in the saturation region are taken as I1 and I2, the currents I1 and I2 are expressed by Formula (1a) and Formula (1b) below.

$$I 1 = \frac{1}{2} μ1 \cdot Cox \frac{W 1}{L 1} {\vert Vth 1 \vert}^{2} \qquad ( 1 a )$$

$$I 2 = \frac{1}{2} μ2 \cdot Cox \frac{W 2}{L 2} {( Vout - Vth 2 )}^{2} \qquad ( 1 b )$$

In Formula (1a) and Formula (1b) above, μ1 and μ2 are carrier mobilities of the transistors M1 and M2, respectively. Cox is an oxide film capacitance of the transistors M1 and M2, respectively. W1 and W2 are gate widths of the transistors M1 and M2, respectively. L1 and L2 are gate lengths of the transistors M1 and M2, respectively. Vth1 and Vth2 are threshold voltages of the transistors M1 and M2, respectively.

In the constant voltage generation circuit 1, I1=I2 holds. Thus, the output voltage Vout is expressed by Formula (2) below.

$$Vout = Vth 2 + \sqrt{\frac{μ1}{μ2} \cdot \frac{W 1 / L 1}{W 2 / L 2}} \vert Vth 1 \vert \qquad ( 2 )$$

The threshold voltage Vth1 of the transistor M1, which is the depletion type, becomes a negative value. Accordingly, Formula (2) above is expressed by Formula (3) below.

$$Vout = Vth 2 - \sqrt{\frac{μ1}{μ2} \cdot \frac{W 1 / L 1}{W 2 / L 2}} Vth 1 \qquad ( 3 )$$

Thus, by appropriately designing W/L of each of the transistors M1 and M2, the temperature characteristics of the threshold voltages Vth1 and Vth2 can be canceled out.

However, such a constant voltage generation circuit 1 of the present comparative example lacks a current capability, and in the case where a load (not shown) connected to the output terminal Tout requires a current capability, there is an issue that the output voltage Vout decreases. An example of a load requiring a current capability is a resistive voltage divider circuit.

### <Constant Voltage Generation Circuit According to the Disclosure>

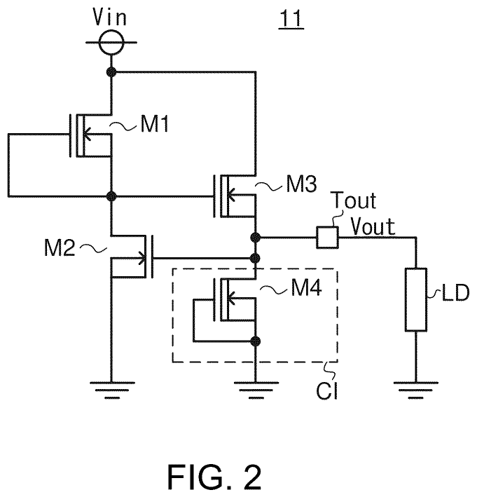

FIG. 2 is a diagram showing a configuration of a constant voltage generation circuit 11 according to an exemplary embodiment of the disclosure. The constant voltage generation circuit 11 includes transistors M3 and M4, in addition to including the transistors M1 and M2 similarly to the above comparative example. Herein, the differences in configuration from the above comparative example will be mainly described.

The transistor M3 is composed of a depletion-type N-channel MOSFET. The drain of the transistor M3 is connected to the drain of the transistor M1. The gate of the transistor M3 is connected to the source of the transistor M1. The source of the transistor M3 is connected to the gate of the transistor M2. The output terminal Tout is connected to the gate of the transistor M2. The output voltage Vout is outputted from the output terminal Tout.

By providing such a transistor M3, a source follower is configured. A current can be supplied to a load LD from the output terminal Tout via the transistor M3, and the constant voltage generation circuit 11 can be provided with a current capability without affecting the output voltage Vout.

In addition, the transistor M4 is composed of a depletion-type N-channel MOSFET. The drain of the transistor M4 is connected to the source of the transistor M3. The gate and the source of the transistor M4 are short-circuited. The source of the transistor M4 is connected to the ground terminal. A constant current source CI is configured by such a transistor M4. The constant current source CI may also be regarded as an active load due to an active element (transistor M4). In the case where the load LD is not connected, a rise in the output voltage Vout can be suppressed by absorbing a leakage current flowing to the transistor M3 in the case of high temperature using the constant current source CI.

In addition, the constant voltage generation circuit 11 according to the present embodiment may be composed of the depletion-type transistors M1, M3, and M4 and the enhancement-type transistor M2. That is, the constant voltage generation circuit 11 may be composed of two types of elements. Accordingly, there are effects such as suppressing the influence due to element variations and being capable of simplifying the element layout.

The transistor M2 may also be configured as a depletion type with a p-type impurity injected into the gate. In that case, the transistors M1, M3, and M4 are a depletion type with an n-type impurity injected into the gate. With the transistor M2 of such a configuration, the threshold voltage can be set to a positive value, and it becomes possible to be used in place of the enhancement type. Furthermore, the transistors M1 to M4 have a common device structure (especially a portion lower than the gate). Thus, the influence due to element variations can be further suppressed. In addition, the element layout can be further simplified.

### Specific First Configuration Example

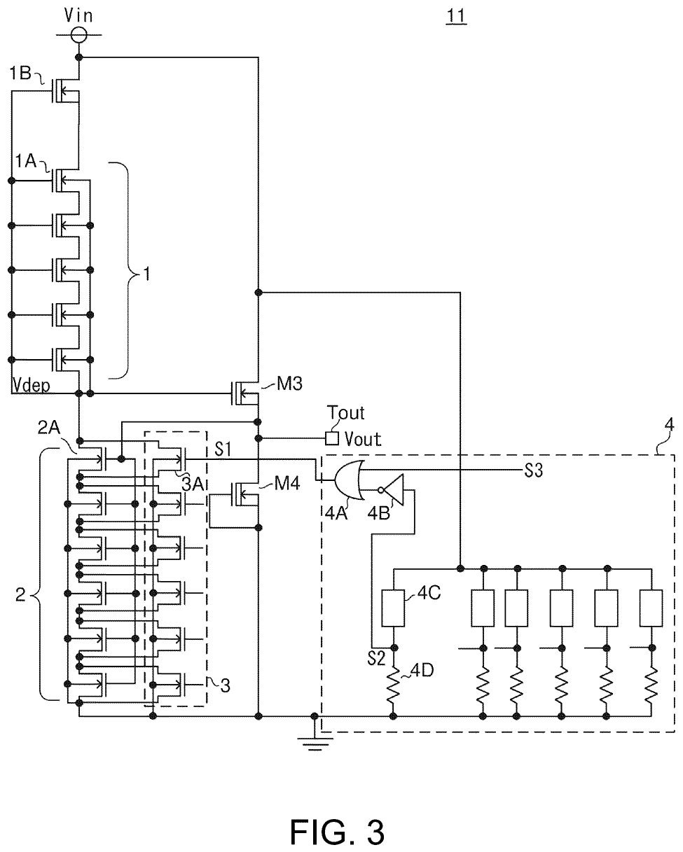

FIG. 3 is a diagram showing a specific first configuration example of the constant voltage generation circuit 11 described above. The constant voltage generation circuit 11 shown in FIG. 3 includes a first transistor stage 1, a second transistor stage 2, a switch circuit 3, and a selection signal generation part 4. In addition, the constant voltage generation circuit 11 includes a third transistor part 1B on the high potential side of the first transistor stage 1. The transistors M3 and M4 described above are also shown in FIG. 3.

The first transistor stage 1 has first transistor parts 1A connected in series. The first transistor part 1A and the third transistor part 1B are each composed of a depletion-type N-channel MOSFET. Each first transistor part 1A is one transistor, and in the example of FIG. 3, five first transistor parts 1A are connected in series. The source and the drain of adjacent first transistor parts 1A are connected to each other. The third transistor part 1B is connected between the application terminal of the input voltage Vin and the drain of the first transistor part 1A on the highest potential side (upper side). The third transistor part 1B is, for example, composed of multiple transistors connected in parallel. The drain of the third transistor part 1B is connected to the application terminal of the input voltage Vin, and the source of the third transistor part 1B is connected to the drain of the first transistor part 1A on the highest potential side. The respective gates of the first transistor parts 1A and the third transistor part 1B are commonly connected to the source of the first transistor part 1A on the lowest potential side (lower side). The respective back gates of the first transistor parts 1A are commonly connected to the source of the first transistor part 1A on the lowest potential side. The back gate of the third transistor part 1B is connected to the source of the third transistor part 1B.

Such a first transistor stage 1 corresponds to the transistor M1 (FIG. 2). For example, in the case where the gate length of each first transistor part 1A is set to 10 μm, the first transistor stage 1 corresponds to a transistor M1 with a gate length L1=10×5 μm. The third transistor part 1B generates a voltage that is higher, by a voltage equivalent to the threshold voltage (negative value) of the third transistor part 1B, than a voltage Vdep, which is the voltage of the source of the first transistor part 1A on the lowest potential side, and is used to suppress the influence of fluctuations in the input voltage Vin.

The configuration of the first transistor stage 1 shown in FIG. 3 is merely an example, and the first transistor stage 1 may also be composed of, for example, one first transistor part 1A.

The second transistor stage 2 has second transistor parts 2A connected in series. Each second transistor part 2A is composed of one transistor and is an enhancement-type N-channel MOSFET. The drain of the second transistor part 2A on the highest potential side is connected to the source of the first transistor part 1A on the lowest potential side. The source and the drain of adjacent second transistor parts 2A are connected to each other. The source of the second transistor part 2A on the lowest potential side is connected to the ground terminal. The respective gates of the second transistor parts 2A are commonly connected to the output terminal Tout. The respective back gates of the second transistor parts 2A are commonly connected to the ground terminal. Any of the second transistor parts 2A may also be composed of multiple transistors connected in parallel. In addition, the number of second transistor parts 2A in the second transistor stage 2 is six in the example of FIG. 3, but may also be any other plural number.

The switch circuit 3 has multiple switches 3A. Each switch 3A is provided corresponding to each second transistor part 2A. The switch 3A is composed of an N-channel MOSFET. The drain of each switch 3A is connected to the drain of each second transistor part 2A, and the source of each switch 3A is connected to the source of each second transistor part 2A. With the switch 3A turned into the on-state, the corresponding second transistor part 2A is bypassed and invalidated. With the switch 3A turned into the off-state, the corresponding second transistor part 2A is validated. The respective back gates of the switches 3A are commonly connected to the ground terminal.

The second transistor stage 2 functions as a transistor M2 (FIG. 2) with a total gate length of the second transistor parts 2A that are validated by the switch circuit 3. Herein, in the example of FIG. 3, for example, the gate lengths of the six second transistor parts 2A are set to 1 μm, 2 μm, 4 μm, 8 μm, 16 μm, and 32 μm, respectively. That is, the gate length is set to 2ⁿ (n is an integer of 0 to m) m (herein, m=5). Accordingly, a gate length from 2⁰ μm to 2⁰+ . . . +2^{m} m can be selected by the switch circuit 3 (in the above example, 1 μm to 63 μm).

The selection signal generation part 4 generates a selection signal S1 for controlling the on/off-state of each switch 3A in the switch circuit 3. The selection signal generation part 4 has a configuration composed of an OR circuit 4A, an inverter 4B, and a combination of a fuse 4C and a resistor 4D connected in series between the application terminal of the input voltage Vin and the ground terminal, with the number of such configurations corresponding to the number of the switches 3A (herein, six). A selection signal S2 outputted from the node where the fuse 4C and the resistor 4D are connected is inputted to a first input terminal of the OR circuit 4A via the inverter 4B. A selection signal S3 is inputted to a second input terminal of the OR circuit 4A. The selection signal S3 is inputted from an electrode pad or a logic part (not shown). The selection signal S1 outputted from the OR circuit 4A is inputted to the gate of the corresponding switch 3A. In the state where the fuse 4C is not cut, the selection signal S2 becomes high level, and the output of the inverter 4B becomes low level. Accordingly, in the state where the fuse 4C is not cut, the level of the selection signal S1, which is the output of the OR circuit 4, can be selected by the selection signal S3. On the other hand, if the selection signal S3 is fixed at low level, the level of the selection signal S1 can be selected by whether the fuse 4C is cut. Specifically, in the case where the fuse 4C is not cut, the selection signal S1 becomes low level, and in the case where the fuse 4C is cut, the selection signal S1 becomes high level. In the case where the selection signal S1 is high level, the switch 3A is turned into the on-state, and in the case where the selection signal S1 is low level, the switch 3A is turned into the off-state.

Next, a selection method of the second transistor parts 2A in the second transistor stage 2 in the constant voltage generation circuit 11 of the configuration shown in FIG. 3 will be described. The selection method is performed by an operator in the following steps.

First, as a first step, in the second transistor stage 2, the second transistor parts 2A to be validated by the switches 3A are selected such that the gate length becomes a specific reference value (e.g., 36 μm). At this time, the on/off of the switches 3A is selected by the selection signal S3 with the fuses 4C uncut. In such a selection state, the output voltage Vout is measured when the temperature is a specific temperature TO (e.g., normal temperature).

As a second step, when in the above selection state and the above temperature state, a drain current Idd1 flowing to the first transistor stage 1, i.e., the transistor M1 (FIG. 2), is measured. Regarding the drain current Idd1, for example, by configuring a state of applying a voltage higher than the output voltage Vout from outside to the output terminal Tout, the transistor M3 is turned into the off-state, and a drain current flowing to the transistor M4 is measured. Since both the transistor M4 and the transistor of the first transistor stage 1 are composed of a depletion-type N-channel MOSFET with the gate and the source short-circuited, there is a tendency of same influence of manufacturing variations, and the drain current Idd1 flowing to the transistor M1 can be estimated based on the measured drain current above. For example, the drain current Idd1 can be estimated according to a ratio of the on-resistance of the transistor M1 to the transistor M4.

As a third step, a gate length L2 in the second transistor stage 2 is determined based on the output voltage Vout measured in the first step, the drain current Idd1 measured in the second step, and a table map.

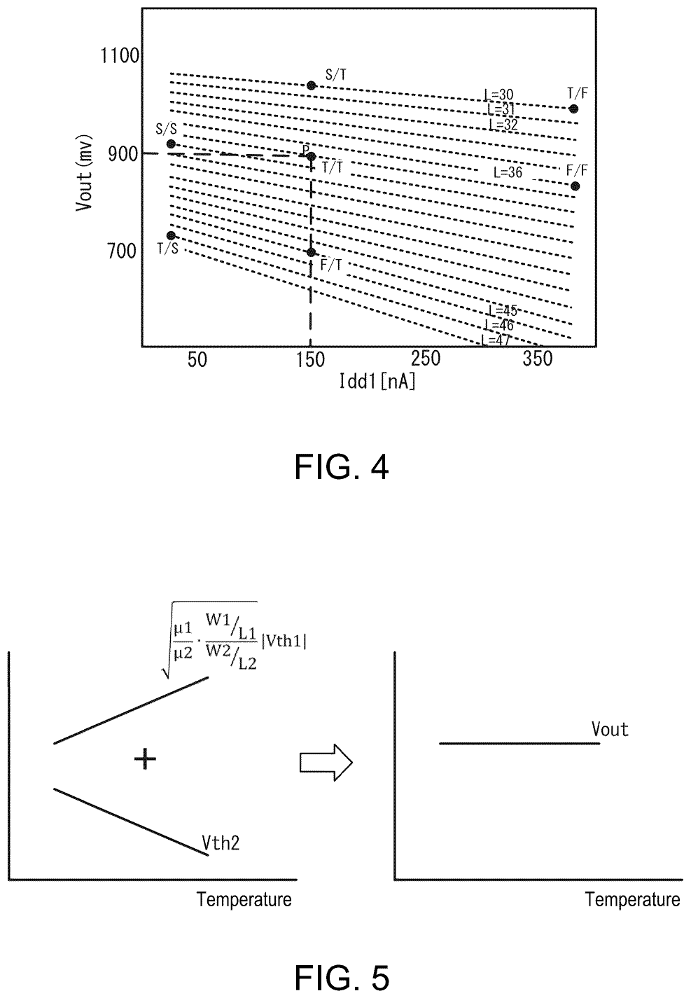

FIG. 4 is a diagram showing an example of the table map. As shown in FIG. 4, in the table map, characteristic lines (straight lines) for each gate length are defined, with the output voltage Vout as the vertical axis and the drain current Idd1 as the horizontal axis. In the table map, the gate length of the characteristic line that intersects with a point P specified by the measured drain current Idd1 and the measured output voltage Vout is determined as the gate length to be selected.

In the example of the table map in FIG. 4, the point P specified by 150 nA, which is the reference value of the drain current Idd1, and 900 mV, which is the reference value of the output voltage Vout, intersects with the characteristic line of the gate length=38 μm, which is the reference value.

Herein, as shown in FIG. 5, in Formula (2) above, the temperature characteristic of

$$\sqrt{\frac{μ1}{μ2} \cdot \frac{W 1 / L 1}{W 2 / L 2}} \vert Vth 1 \vert \qquad ( A )$$

has a positive temperature characteristic due to the temperature characteristic of Vth1, and the temperature characteristic of Vth2 has a negative temperature characteristic. The gate length L1 is the gate length of the transistor M1, and the gate length L2 is the gate length of the transistor M2. In the configuration of FIG. 3, L1 is fixed. According to Formula (2) above, a sum of the temperature characteristic of the value of (A) above and the temperature characteristic of Vth2 becomes the temperature characteristic of the output voltage Vout.

Herein, the transistor M1, which is the depletion type, and the transistor M2, which is the enhancement type, have current capabilities that vary due to manufacturing variations. Hereinafter, a current capability of a typical value is represented by T (Typ), a higher current capability is represented by F (Fast), a lower current capability is represented by S (Slow), and a combination of the current capabilities of the transistors M1 and M2 due to variations is expressed as ENH/DEP. For example, if both the transistor M1 and the transistor M2 have typical values, it is expressed as ENH/DEP=T/T.

In the case of ENH/DEP=T/T, the parameters (mobility, gate width, gate length) in (A) above are values corresponding to the current capability of a typical value, and as shown in FIG. 4, the point P representing the combination of Idd1 and Vout is located on the characteristic line of L2=36 μm, which is the reference value. That is, with L2=36 μm, as shown in FIG. 5, the temperature characteristic of Vout becomes almost flat.

Herein, in the case where the current capabilities of the transistors M1 and M2 vary in the same direction, as in ENH/DEP=S/S or T/T, since the parameters in (A) above also vary in the same direction, as shown in FIG. 4, the point P is located at, for example, L2=37 μm or 35 μm, and even if L2 is kept at the reference value (36 μm), the temperature characteristic becomes close to flat.

In addition, in the case of ENH/DEP=S/T or F/T, as shown in FIG. 4, the value of Vout at the point P becomes higher or lower compared to the case of ENH/DEP=T/T. In the case of ENH/DEP=S/T, the temperature characteristic of Vout becomes a positive temperature characteristic, and in the case of ENH/DEP=F/T, the temperature characteristic of Vout becomes a negative temperature characteristic, both of which are a characteristic that is not flat. Thus, as shown in FIG. 4, by adjusting L2 to, for example, L2=30 μm, in the case of ENH/DEP=S/T and to, for example, L2=44 μm, in the case of ENH/DEP=F/T, the temperature characteristic can be brought closer to flat.

In addition, in the case of ENH/DEP=T/F, as shown in FIG. 4, the value of Idd1 and the value of Vout at the point P respectively become higher compared to the case of ENH/DEP=T/T. In that case, the temperature characteristic of Vout becomes a positive temperature characteristic, and as shown in FIG. 4, by adjusting L2 to, for example, L2=30 μm, the temperature characteristic can be brought closer to flat. Similarly, in the case of ENH/DEP=T/S, as shown in FIG. 4, the value of Idd1 and the value of Vout at the point P respectively become lower compared to the case of ENH/DEP=T/T. In that case, the temperature characteristic of Vout becomes a negative temperature characteristic, and as shown in FIG. 4, by adjusting L2 to, for example, L2=46 μm, the temperature characteristic can be brought closer to flat.

In this manner, by adjusting L2 to the value of L2 on the characteristic line where the point P, representing the combination of Idd1 and Vout, intersects in a table map as shown in FIG. 4, for example, the temperature characteristic of Vout can be brought closer to flat.

Then, in a fourth step, cutting/non-cutting of each fuse 4C in the selection signal generation part 4 is determined to select the second transistor parts 2A to be validated such that the gate length L2 in the second transistor stage 2 becomes the gate length determined above. During use as a product, the selection signal S3 is fixed at low level.

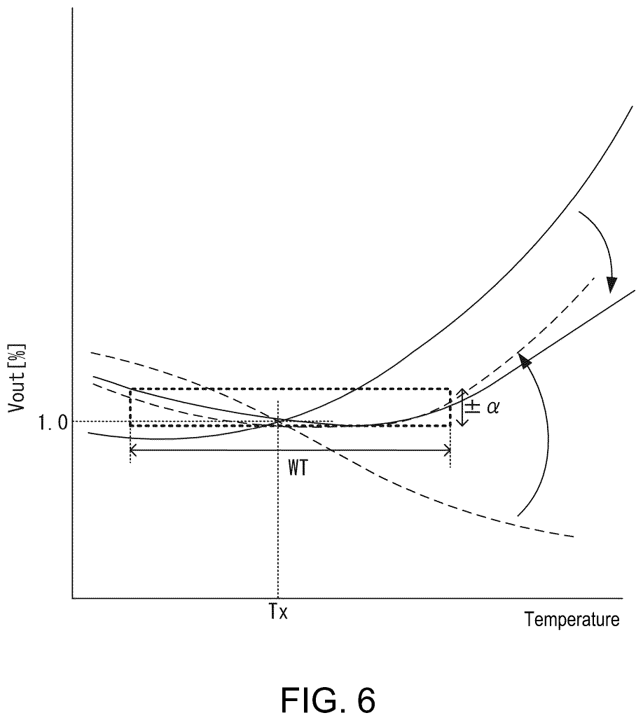

Herein, FIG. 6 is a diagram showing an example of temperature characteristics of the output voltage Vout. In FIG. 6, the output voltage Vout is shown, with the value of the output voltage Vout at a specific normal temperature Tx being set to 1.0%. By adjusting the gate length L2 in the second transistor stage 2 as described above, for example, the positive temperature characteristic before correction (solid line) can be corrected as indicated by an arrow, and the negative temperature characteristic before correction (broken line) can be corrected as indicated by an arrow. Accordingly, the output voltage Vout can be kept within 1a % in a temperature domain WT indicated by a broken line frame in FIG. 6.

### Specific Second Configuration Example

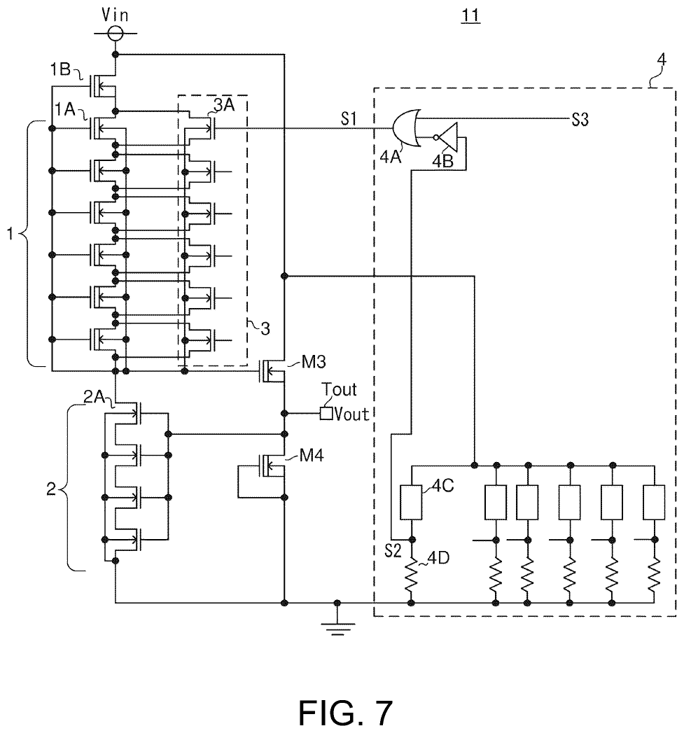

FIG. 7 is a diagram showing a specific second configuration example of the constant voltage generation circuit 11 described above. Herein, the differences in configuration from the first configuration example (FIG. 3) will be mainly described.

In the configuration shown in FIG. 7, the switches 3A in the switch circuit 3 are provided corresponding to the respective first transistor parts 1A in the first transistor stage 1. That is, validation/invalidation of the corresponding first transistor part 1A is switched by the switch 3A. The selection signal S1 generated by the selection signal generation part 4 is inputted to the gate of the switch 3A. The gate lengths of the first transistor parts 1A are set to the respective values. A part of the first transistor parts 1A, for example, may also be composed of multiple transistors connected in parallel. For example, in the case where a part of the first transistor parts 1A is configured as one transistor with a gate length of 50 μm, one transistor with a gate length of 5 μm, and two transistors with a gate length of 5 μm connected in parallel, by validating these first transistor parts 1A, L1 can be set to 50+5+5/2=47.5 μm. As described above, the third transistor part 1B is used to suppress the influence of fluctuations in the input voltage Vin.

In addition, in the configuration of FIG. 7, a circuit for selecting the second transistor parts 2A in the second transistor stage 2 is not provided, and the gate length L2 in the second transistor stage 2 is fixed.

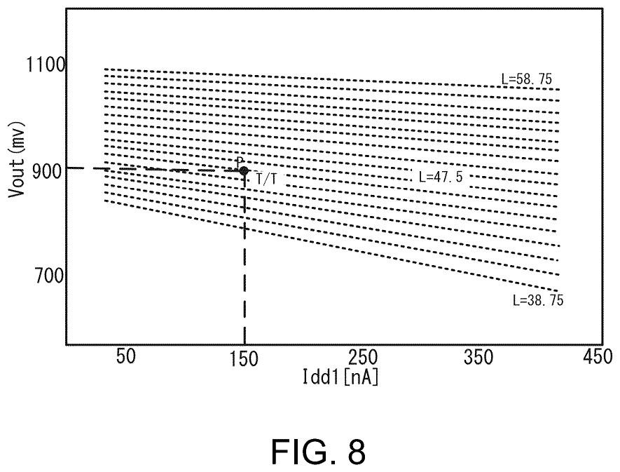

In such a configuration of FIG. 7, regarding a selection method of the first transistor parts 1A in the first transistor stage 1, a table map as shown in FIG. 8, for example, is used in the same manner as in the embodiment described above. In this table map, the characteristic line of the gate length L1 is defined.

That is, in the case where the temperature is set to a specific temperature with the gate length L1 in the first transistor parts 1A as a reference value, the drain current Idd1 and the output voltage Vout are measured, and the gate length L1 is determined based on the measurement results and the table map. In the example of FIG. 8, the reference value of the gate length L1 is set to 47.5 μm. As shown in FIG. 8, in the table map, the lower the output voltage Vout is, the shorter the gate length L1 of the characteristic line becomes, which is a relationship inverse to the gate length L2 of the characteristic line shown in the table map of FIG. 4 described above.

In the configuration shown in FIG. 3 or FIG. 7, the on-resistance of the switch 3A needs to be configured to be lower than the on-resistance of the transistor part serving as the selection target. However, by providing the switches 3A for the first transistor stage 1 as in the configuration shown in FIG. 7, since the on-resistance of the first transistor part 1A is relatively high, the on-resistance of the switch 3A may be configured to be relatively high, and the circuit area due to the switches 3A can be suppressed.

On the other hand, with the configuration shown in FIG. 3, since the switch circuit 3 is provided on the low potential side, the operating voltage in the input voltage Vin can be configured to be lower.

### <Leakage Current Countermeasures>

### First Embodiment

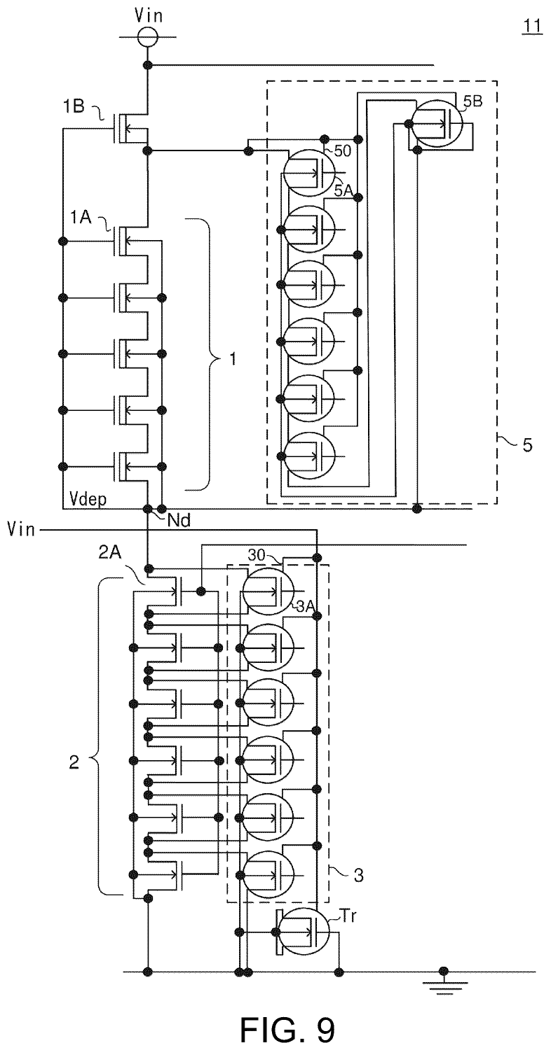

Herein, leakage current countermeasures in the constant voltage generation circuit as described above will be described. FIG. 9 shows a first embodiment in which a leakage current countermeasure is implemented in the constant voltage generation circuit 11 (FIG. 3) according to the first configuration example described above.

In FIG. 9, a leakage current occurs at high temperature in the switch 3A constituting the switch circuit 3. The leakage current occurs between the drain and the source, between the drain and the back gate, and between the source and the back gate. Since these leakage currents are extracted from a node Nd (a node to which the drain of the switch 3A on the highest potential side is connected) at which the voltage Vdep is generated, there is a risk that the voltage Vdep may decrease at high temperature. In particular, since the switch 3A needs to have an on-resistance lowered and is large in size, the influence of the leakage current is significant.

Thus, in FIG. 9, a leakage cancellation circuit 5 is provided in the constant voltage generation circuit 11. In the disclosure, “cancellation” includes not only complete cancellation of the leakage current but also partial cancellation of the leakage current.

The leakage cancellation circuit 5 includes multiple MOS transistors 5A and one MOS transistor 5B. Each of the multiple MOS transistors 5A has the same configuration as each of the switches 3A. That is, each of the multiple MOS transistors 5A is composed of an enhancement-type N-channel MOSFET. Herein, “same configuration” indicates that the polarity (N type or P type) of the transistor, the size, etc. are the same, but errors that actually occur may be included even if the design is the same. “Same size” means that the sizes of the main electrodes (drain, source, gate, etc.) of the transistor and each layer constituting the transistor are the same.

The multiple MOS transistors 5A are connected in series. That is, the source and the drain of adjacent MOS transistors 5A are connected to each other. The drain of the MOS transistor 5A on the highest potential side is connected to the source of the third transistor part 1B. The MOS transistor 5B is composed of an enhancement-type N-channel MOSFET. The drain of the MOS transistor 5B is connected to the source of the MOS transistor 5A on the lowest potential side. The source of the MOS transistor 5B is connected to the application terminal (i.e., node Nd) of Vdep. The respective back gates of the multiple MOS transistors 5A are commonly connected to the back gate of the MOS transistor 5B. The back gate and the source of the MOS transistor 5B are short-circuited.

The gate of each of the multiple MOS transistors 5A is connected to the gate of the switch 3A corresponding to the MOS transistor 5A. That is, the selection signal S1 is commonly inputted to the gates of each of the corresponding switch 3A and the MOS transistor 5A. For example, the selection signal S1 inputted to the gate of the switch 3A on the highest potential side is also inputted to the gate of the MOS transistor 5A on the highest potential side. Accordingly, the corresponding switch 3A and the MOS transistor 5A are synchronized to be turned into the on-state or the off-state according to the selection signal S1.

The gate and the source of the MOS transistor 5B are short-circuited. Thus, the MOS transistor 5B is in the off-state. Accordingly, the influence of the MOS transistor 5A on the voltage Vdep at normal temperature (when not at high temperature) is suppressed. The MOS transistor 5B is not essential. In addition, in the case where there is no switch 3A corresponding to a part of the second transistor parts 2A (e.g., the second transistor part 2A on the highest potential side) in the second transistor stage 2, since there may be cases where all the switches 3A are turned into the on-state, there is high significance in turning the MOS transistor 5B into the off-state.

By providing such a leakage cancellation circuit 5, the leakage currents generated between the drain and the source, between the drain and the back gate, and between the source and the back gate of the MOS transistor 5A is injected into the node Nd, and thus the leakage current generated in the switch circuit 3 can be canceled out, and a decrease in the voltage Vdep can be suppressed.

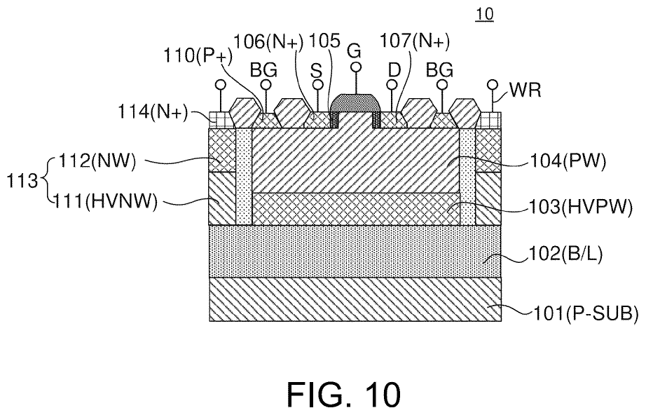

As shown in FIG. 9, wirings 30 connected to each of the multiple switches 3A are commonly connected to the application terminal of the input voltage Vin. Herein, FIG. 10 shows an example of a vertical structure of an N-channel MOSFET. That is, the structure shown in FIG. 10 applies to both the switch 3A and the MOS transistor 5A.

The N-channel MOSFET 10 shown in FIG. 10 has the following structure. A base substrate 101 is a P-type semiconductor substrate. An N-type buried layer (B/L) 102 is formed above the base substrate 101. A P-type well layer (HVPW) 103 is formed above the buried layer 102. A P-type well layer (PW) 104 is formed above the P-type well layer 103.

At a surface layer part of the P-type well layer 104, a pair of N-type LDD layers (MVNLDD) 105 are formed with an interval therebetween. In the pair of N-type LDD layers 105, an n⁺-type source layer 106 and an n⁺-type drain layer 107 are formed, respectively. The region between the pair of N-type LDD layers 105 is a channel region 108. A gate electrode 109 is formed above the channel region 108. A source (S) wiring is connected to the n⁺-type source layer 106. A drain (D) wiring is connected to the n⁺-type drain layer 107.

At the surface layer part of the P-type well layer 104, a P⁺-type layer 110 is formed on the outer peripheral side of the n⁺-type source layer 106 and the n⁺-type drain layer 107. A back gate (BG) wiring is connected to the P⁺-type layer 110.

An intermediate layer 113 is formed on the outer peripheral side of the P-type well layers 103 and 104 above the buried layer 102. The intermediate layer 113 has an N-type well layer 111 at a lower part and an N-type well layer 112 at an upper part. A P⁺-type layer 114 is formed above the N-type well layer 112. A wiring WR is formed on the P⁺-type layer 114.

The wiring WR corresponds to the wiring 30 connected to the switch 3A. The leakage current flowing through the back gate via the wiring 30 and the buried layer 102 in the switch 3A from the application terminal of the input voltage Vin does not affect the voltage Vdep. However, the wiring WR corresponds to a wiring 50 connected to the MOS transistor 5A, and each wiring 50 of the multiple MOS transistors 5A is connected to the source of the third transistor part 1B. Accordingly, since the leakage current flowing through the back gate via the wiring 50 and the buried layer 102 in the MOS transistor 5A is injected into the node Nd, the leakage current affects the voltage Vdep. However, since this leakage current is small, its influence on the voltage Vdep is small.

In FIG. 9, the total number of the MOS transistors 5A and the MOS transistor 5B is seven, and the total number of the switches 3A and the MOS transistor Tr is also seven, which is the same number, but the MOS transistor Tr is used as a dummy. Specifically, the back gate, the drain, and the source of the MOS transistor Tr are short-circuited, and the back gate is connected to the ground terminal. In addition, the gate of the MOS transistor Tr is connected to the ground terminal. In addition, the wiring corresponding to the wiring WR connected to the MOS transistor Tr is connected to the application terminal of the input voltage Vin.

### Second Embodiment

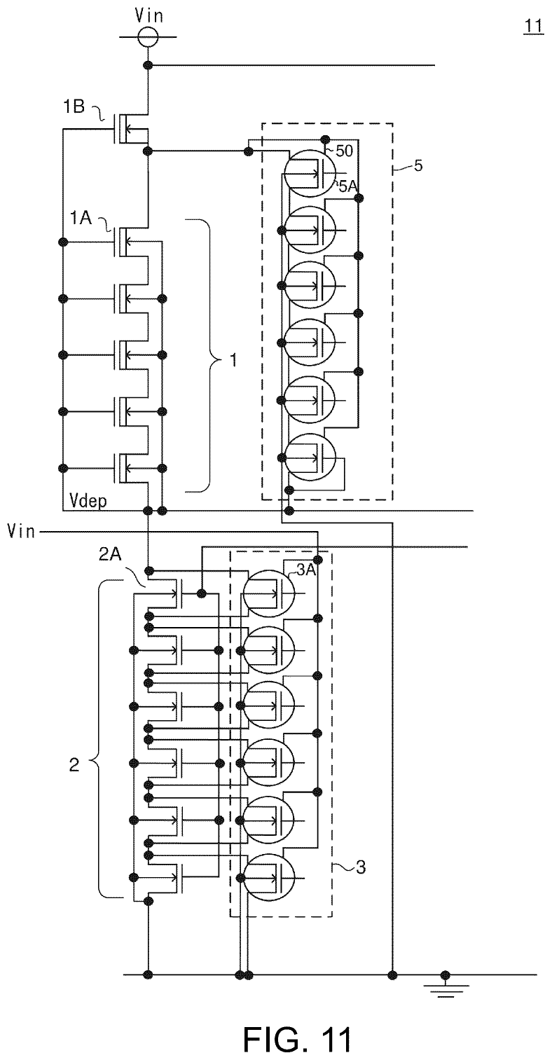

FIG. 11 shows a second embodiment in which a leakage current countermeasure is implemented in the constant voltage generation circuit 11 (FIG. 3) according to the first configuration example described above.

The difference between the present embodiment and the first embodiment (FIG. 9) lies in that the respective back gates of the multiple MOS transistors 5A in the leakage cancellation circuit 5 are connected to the ground terminal. Accordingly, since the leakage current flowing through the back gate via the wiring 50 and the buried layer 102 in the MOS transistor 5A flows to the ground terminal, the influence on the voltage Vdep can be suppressed. However, in the present embodiment, since the leakage currents flowing between the drain and the back gate and between the source and the back gate of the switch 3A are not canceled out, the first embodiment is more advantageous in this aspect.

As shown in FIG. 11, the MOS transistor 5A on the lowest potential side in the leakage cancellation circuit 5 has its gate and source short-circuited. Accordingly, the MOS transistor 5A is turned into the off-state, and the influence on the voltage Vdep at normal temperature is suppressed.

### Third Embodiment

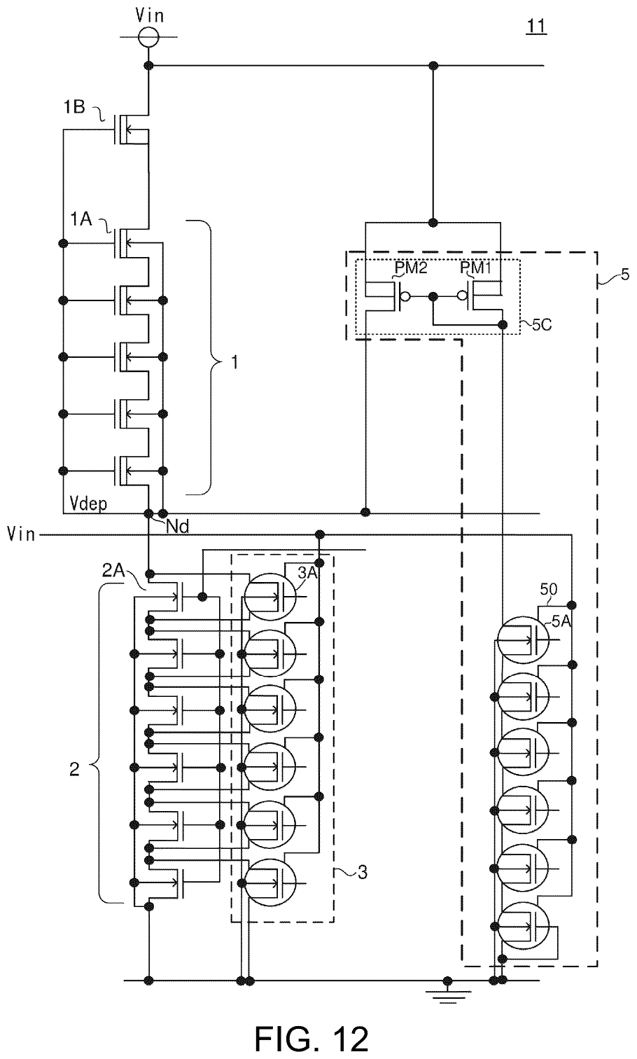

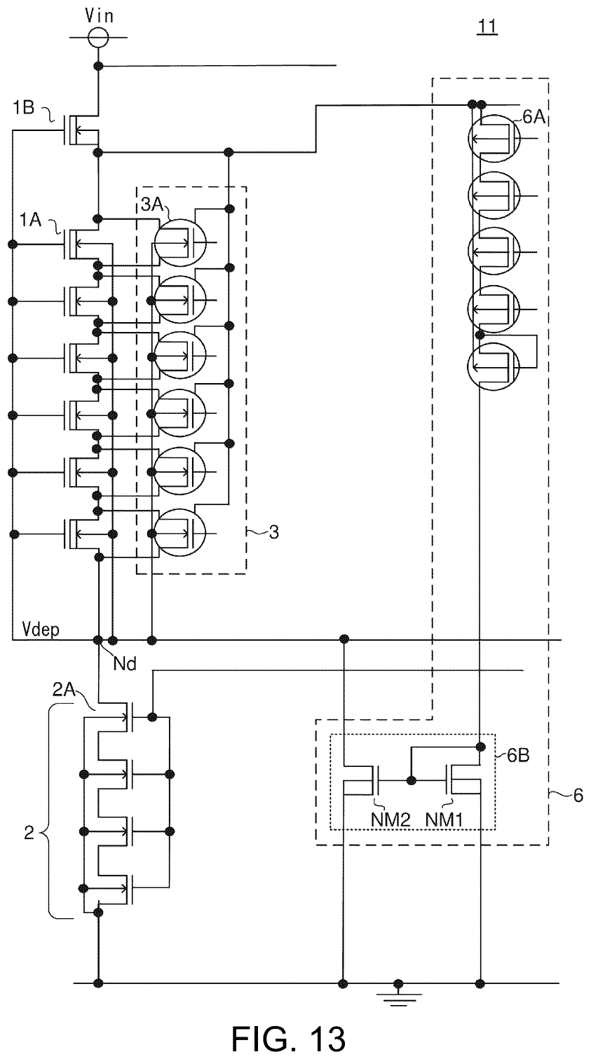

FIG. 12 shows a third embodiment in which a leakage current countermeasure is implemented in the constant voltage generation circuit 11 (FIG. 3) according to the first configuration example described above.

In the present embodiment, as shown in FIG. 12, the leakage cancellation circuit 5 includes a current mirror 5C in addition to the MOS transistors 5A. The respective back gates of the multiple MOS transistors 5A are commonly connected to the ground terminal. The gate and the source of the MOS transistor 5A on the lowest potential side are short-circuited, and the source is connected to the ground terminal.

The current mirror 5C includes PMOS transistors PM1 and PM2. The PMOS transistors PM1 and PM2 are composed of P-channel MOSFETs. The drain of the PMOS transistor PM1 is connected to the drain of the MOS transistor 5A on the highest potential side. The gate and the drain of the PMOS transistor PM1 are short-circuited. The sources of the PMOS transistors PM1 and PM2 are connected to the application terminal of the input voltage Vin. The gates of the PMOS transistors PM1 and PM2 are connected to each other. The drain of the PMOS transistor PM2 is connected to the node Nd.

With such a configuration, the leakage currents flowing between the drain and the source, between the drain and the back gate, and between the source and the back gate of the MOS transistor 5A are mirrored by the current mirror 5C and injected into the node Nd. Accordingly, the leakage current flowing to the switch circuit 3 can be canceled out, and fluctuations in the voltage Vdep can be suppressed. In addition, in the present embodiment, since the wiring 50 connected to the MOS transistor 5A is connected to the application terminal of the input voltage Vin, the leakage current flowing through the back gate via the wiring 50 and the buried layer 102 in the MOS transistor 5A from the application terminal of the input voltage Vin flows to the ground terminal, and the influence on the voltage Vdep is suppressed.

### Fourth Embodiment

FIG. 13 shows a fourth embodiment in which a leakage current countermeasure is implemented in the constant voltage generation circuit 11 (FIG. 7) according to the second configuration example described above.

In the present embodiment, a leakage cancellation circuit 6 is provided. The leakage cancellation circuit 6 includes multiple MOS transistors 6A and a current mirror 6B. The MOS transistor 6A is composed of a P-channel MOS transistor. The multiple MOS transistors 6A are connected in series. The drain and the source of adjacent MOS transistors 6A are connected to each other. The source of the MOS transistor 6A on the highest potential side is connected to the source of the third transistor part 1B. The respective back gates of the multiple MOS transistors 6A are commonly connected to the source of the third transistor part 1B. The buried layer of the MOS transistor 6A is connected to the back gate.

The current mirror 6B includes NMOS transistors NM1 and NM2. The NMOS transistors NM1 and NM2 are composed of N-channel MOSFETs. The drain of the NMOS transistor NM1 is connected to the drain of the MOS transistor 6A on the lowest potential side. The gate and the drain of the NMOS transistor NM1 are short-circuited. The sources of the NMOS transistor NM1 and NM2 are connected to the ground terminal. The gates of the NMOS transistors NM1 and NM2 are connected to each other. The drain of the NMOS transistor NM2 is connected to the node Nd. The gate and the source of the MOS transistor 6A on the lowest potential side are short-circuited.

With such a configuration, by mirroring the leakage current flowing to the MOS transistor 6A using the current mirror 6B and extracting from the node Nd, the leakage current flowing to the switch circuit 3 can be canceled out, and fluctuations in the voltage Vdep can be suppressed.

### Others

In addition to the above embodiments, various technical features disclosed in this specification may be modified in various manners within a range that does not deviate from the gist of the technical creation. That is, the above embodiments should be considered as illustrative in all aspects and not restrictive, and the technical scope of the disclosure is not limited to the above embodiments, but should be understood to include all modifications belonging to the equivalent meaning and scope of the claims.

For example, the countermeasures against a leakage current as described above may be applied not only to a constant voltage generation circuit but also to other circuits. The target elements of which validation/invalidation is switched by the switch 3A in the switch circuit 3 is not limited to MOSFETs as in the embodiments described above, but may also be, for example, resistive elements.

### APPENDIX

As described above, a semiconductor device (200) according to an aspect of the disclosure includes:
a switch circuit (3) having at least one switch (3A) configured as a MOSFET connected between two terminals of a specific element (2A); and
a leakage cancellation circuit (5) having at least one MOS transistor (5A) configured as a MOSFET, connected to the switch circuit at a specific node (Nd), and configured to inject or extract a leakage current with respect to the specific node (first configuration, FIG. 9).

According to such a configuration, since the leakage current generated in the switch circuit at high temperature can be canceled out by the leakage cancellation circuit, the influence of the leakage current can be suppressed.

In addition, in the first configuration, the MOS transistor (5A) may be configured as a MOSFET of a same polarity (e.g., N-channel type) as the switch (3A) (second configuration, FIG. 9).

In addition, in the second configuration, in the switch circuit, multiple switches (3A) may be connected in series,
in the leakage cancellation circuit, multiple MOS transistors (5A) may be connected in series, and
each of the multiple MOS transistors may have a same configuration as each of the multiple switches (third configuration, FIG. 9).

In addition, in the third configuration, respective gates of the multiple MOS transistors (5A) may be connected to respective gates of the multiple switches (3A) (fourth configuration, FIG. 9).

In addition, in any of the first to fourth configurations, in the leakage cancellation circuit, multiple MOS transistors (5A) may be connected in series,
respective back gates of the multiple MOS transistors may be connected to the specific node (Nd), and
a source of the MOS transistor on a lowest potential side among the multiple MOS transistors may be directly or indirectly connected to the specific node (fifth configuration, FIG. 9).

In addition, in any of the first to fourth configurations, in the leakage cancellation circuit, multiple MOS transistors (5A) may be connected in series,
respective back gates of the multiple MOS transistors may be connected to an application terminal of a ground potential, and
a source of the MOS transistor on a lowest potential side among the multiple MOS transistors may be directly or indirectly connected to the specific node (Nd) (sixth configuration, FIG. 11).

In addition, in any of the first to fourth configurations, in the leakage cancellation circuit, multiple MOS transistors (5A) configured as N-channel MOSFETs may be connected in series,
respective back gates of the multiple MOS transistors may be connected to an application terminal of a ground potential,
a source of the MOS transistor on a lowest potential side among the multiple MOS transistors may be directly or indirectly connected to the application terminal of the ground potential,
the leakage cancellation circuit may further include a first current mirror (5C), and
the first current mirror may include:
a first PMOS transistor (PM1) having a drain connected to a drain of the MOS transistor on a highest potential side among the multiple MOS transistors; and
a second PMOS transistor (PM2) having a drain connected to the specific node (Nd) (seventh configuration, FIG. 12).

In addition, in any of the first to fourth configurations, in the leakage cancellation circuit (6), multiple MOS transistors (6A) configured as P-channel MOSFETs may be connected in series,
respective back gates of the multiple MOS transistors may be connected to an application terminal of a specific voltage,
a source of the MOS transistor on a highest potential side among the multiple MOS transistors may be connected to the application terminal of the specific voltage,
the leakage cancellation circuit may further include a second current mirror (6B), and
the second current mirror may include:
a first NMOS transistor (NM1) having a drain connected to a drain of the MOS transistor on a lowest potential side among the multiple MOS transistors; and
a second NMOS transistor (NM2) having a drain connected to the specific node (Nd) (eighth configuration, FIG. 13).

In addition, in any of the first to eighth configurations, in the leakage cancellation circuit (5), multiple MOS transistors (5A) may be connected in series, and
the leakage cancellation circuit may further include a transistor (5B) that is connected to the MOS transistor on a lowest potential side among the multiple MOS transistors and has a gate and a source short-circuited (ninth configuration, FIG. 9).

In addition, in any of the first to eighth configurations, in the leakage cancellation circuit (5), multiple MOS transistors (5A) may be connected in series, and
a gate and a source of the MOS transistor on a lowest potential side among the multiple MOS transistors may be short-circuited (tenth configuration, FIG. 11).

In addition, any of the first to tenth configurations may include a constant voltage generation circuit (11) including:
a first transistor stage (1) configured by multiple first transistor parts (1A) as depletion-type N-channel MOSFETs connected in series;
a second transistor stage (2) connected to the first transistor stage at the specific node (Nd), and configured by multiple second transistor parts (2A) as enhancement-type N-channel MOSFETs connected in series;
the switch circuit (3) including multiple switches (3A); and
the leakage cancellation circuit (5), and
the multiple switches may be respectively connected between two terminals of each of the multiple first transistor parts serving as the specific elements, or between two terminals of each of the multiple second transistor parts serving as the specific elements (eleventh configuration, FIG. 9).

The disclosure may be utilized, for example, in various circuits such as a constant voltage generation circuit.

What is claimed is:

1. A semiconductor device comprising:
a switch circuit having at least one switch configured as a MOSFET connected between two terminals of a specific element; and
a leakage cancellation circuit having at least one MOS transistor configured as a MOSFET, connected to the switch circuit at a specific node, and configured to inject or extract a leakage current with respect to the specific node.

2. The semiconductor device according to claim 1, wherein
the MOS transistor is configured as a MOSFET of a same polarity as the switch.

3. The semiconductor device according to claim 2, wherein
in the switch circuit, a plurality of the switches are connected in series,
in the leakage cancellation circuit, a plurality of the MOS transistors are connected in series, and
each of the plurality of the MOS transistors has a same configuration as each of the plurality of the switches.

4. The semiconductor device according to claim 3, wherein
respective gates of the plurality of the MOS transistors are connected to respective gates of the plurality of the switches.

5. The semiconductor device according to claim 1, wherein
in the leakage cancellation circuit, a plurality of the MOS transistors are connected in series,
respective back gates of the plurality of the MOS transistors are connected to the specific node, and
a source of the MOS transistor on a lowest potential side among the plurality of the MOS transistors is directly or indirectly connected to the specific node.

6. The semiconductor device according to claim 1, wherein
in the leakage cancellation circuit, a plurality of the MOS transistors are connected in series,
respective back gates of the plurality of the MOS transistors are connected to an application terminal of a ground potential, and
a source of the MOS transistor on a lowest potential side among the plurality of the MOS transistors are directly or indirectly connected to the specific node.

7. The semiconductor device according to claim 1, wherein
in the leakage cancellation circuit, a plurality of the MOS transistors configured as N-channel MOSFETs are connected in series,
respective back gates of the plurality of the MOS transistors are connected to an application terminal of a ground potential,
a source of the MOS transistor on a lowest potential side among the plurality of the MOS transistors is directly or indirectly connected to the application terminal of the ground potential,
the leakage cancellation circuit further comprises a first current mirror, and
the first current mirror comprises:
a first PMOS transistor having a drain connected to a drain of the MOS transistor on a highest potential side among the plurality of the MOS transistors; and
a second PMOS transistor having a drain connected to the specific node.

8. The semiconductor device according to claim 1, wherein
in the leakage cancellation circuit, a plurality of the MOS transistors configured as P-channel MOSFETs are connected in series,
respective back gates of the plurality of the MOS transistors are connected to an application terminal of a specific voltage,
a source of the MOS transistor on a highest potential side among the plurality of the MOS transistors is connected to the application terminal of the specific voltage,
the leakage cancellation circuit further comprises a second current mirror, and
the second current mirror comprises:
a first NMOS transistor having a drain connected to a drain of the MOS transistor on a lowest potential side among the plurality of the MOS transistors; and
a second NMOS transistor having a drain connected to the specific node.

9. The semiconductor device according to claim 1, wherein
in the leakage cancellation circuit, a plurality of the MOS transistors are connected in series, and
the leakage cancellation circuit further comprises a transistor that is connected to the MOS transistor on a lowest potential side among the plurality of the MOS transistors and has a gate and a source short-circuited.

10. The semiconductor device according to claim 1, wherein
in the leakage cancellation circuit, a plurality of the MOS transistors are connected in series, and
a gate and a source of the MOS transistor on a lowest potential side among the plurality of the MOS transistors are short-circuited.

11. The semiconductor device according to claim 1, comprising:
a constant voltage generation circuit comprising:
a first transistor stage configured by a plurality of first transistor parts as depletion-type N-channel MOSFETs connected in series;
a second transistor stage connected to the first transistor stage at the specific node, and configured by a plurality of second transistor parts as enhancement-type N-channel MOSFETs connected in series;
the switch circuit comprising a plurality of the switches; and
the leakage cancellation circuit, wherein
the plurality of the switches are respectively connected between two terminals of each of the plurality of first transistor parts serving as the specific elements, or between two terminals of each of the plurality of second transistor parts serving as the specific elements.
